(19) United States
(12) Patent Application Publication
(10) Pub. No.: US 2004/0149754 A1
(43) Pub. Date: Aug. 5, 2004

(54) Stackable containers

(76) Inventor: Asher Diamant, Holon (IL)

Correspondence Address: ABELMAN FRAYNE & SCHWAB, 150 East 42nd Street, New York, NY, 10017, US

(21) Appl. No.: 10/354,740

(22) Filed: Jan. 30, 2003

(51) Int. Cl. A47G 19/00; B65D 21/02

(52) U.S. Cl. 220/23.6

(57) ABSTRACT

A stackable drawer enclosure including an enclosure element formed of carton and front and rear end elements formed of plastic, joined to the enclosure element and providing removable attachment with similar drawer enclosures stacked thereon.

### FIELD OF THE INVENTION

The present invention relates to stackable containers generally and more particularly to stackable containers, such as drawers, formed of disparate materials.

### BACKGROUND OF THE INVENTION

Various types of stackable containers are known. The following U.S. patents are believed to represent the current state of the art:

U.S. Pat. Nos. 6,443,358; 6,250,490 and 6,247,593.

### SUMMARY OF THE INVENTION

The present invention seeks to provide an improved stackable container.

There is thus provided in accordance with a preferred embodiment of the present invention a stackable drawer enclosure including an enclosure element formed of carton and front and rear end elements formed of plastic, joined to the enclosure element and providing removable attachment with similar drawer enclosures stacked thereon.

Preferably, the front end element also includes a latch element. Additionally, the latch element slidably engages an opening in a corresponding protrusion formed in a corresponding stackable element.

In accordance with another preferred embodiment of the present invention the front end element also includes a slot. Preferably, the slot is operative to engage a cuttable retaining ring.

Preferably, the rear end element also includes a latch. Additionally, the latch clickably engages an opening in a corresponding protrusion formed in a corresponding stackable element.

There is also provided in accordance with another preferred embodiment of the present invention a stackable drawer enclosure including an enclosure element and front and rear end elements, joined to the enclosure element and providing removable attachment with similar drawer enclosures stacked thereon, at least one of the front and rear end elements including at least one slidable engagement protrusion and at least one slidable engagement recess arranged for mutual slidable engagement and disengagement between adjacent stacked drawer enclosures.

Preferably, the front end element also includes a slot. Additionally, the slot is operative to engage a cuttable retaining ring.

### BRIEF DESCRIPTION OF THE DRAWINGS

The present invention will be understood and appreciated more fully from the following detailed description, taken in conjunction with the drawings in which:

FIG. 1 is a simplified illustration of a scored cardboard blank useful in manufacturing a drawer enclosure constructed and operative in accordance with a preferred embodiment of the present invention;

FIG. 2 is a simplified exploded view illustration of a drawer enclosure constructed and operative in accordance with a preferred embodiment of the present invention, using the blank of FIG. 1;

FIGS. 3A, 3B, 3C and 3D are illustrations of part of the drawer enclosure of FIG. 2 taken along arrows IIIA, IIIB and IIIC in FIG. 2 and section lines IIID-IIID in FIG. 3B;

FIGS. 4A, 4B, 4C and 4D are illustrations of another part of the drawer enclosure of FIG. 2 taken along arrows IVA, IVB and IVC in FIG. 2 and section lines IVD-IVD in FIG. 4B;

FIG. 5A is a simplified assembled view illustration of the drawer enclosure of FIGS. 2-4C;

FIG. 5B is a simplified assembled view illustration of an alternative embodiment the drawer enclosure of FIGS. 2-4C;

FIGS. 6A, 6B and 6C are respective simplified pictorial, side view and sectional illustrations of an intermediate stage in stacking drawer enclosures of the type shown in FIGS. 2-5B;

FIGS. 7A and 7B are respective pictorial and side view illustrations of the drawer enclosures of FIGS. 2-6C in full engagement;

FIG. 8 is a sectional illustration taken along the lines VIII-VIII in FIG. 7B;

FIG. 9 is a sectional illustration taken along the lines IX-IX in FIG. 8;

FIG. 10 is a sectional illustration taken along the lines X-X in FIG. 7B;

FIG. 11 is a sectional illustration taken along the lines XI-XI in FIG. 10;

FIGS. 12A-12D are pictorial illustrations showing securing and unsecuring drawers in drawer enclosures; and

FIG. 13 is a pictorial illustration of one example of stacking disparately sized drawer enclosures in accordance with a preferred embodiment of the present invention.

### DETAILED DESCRIPTION OF A PREFERRED EMBODIMENT

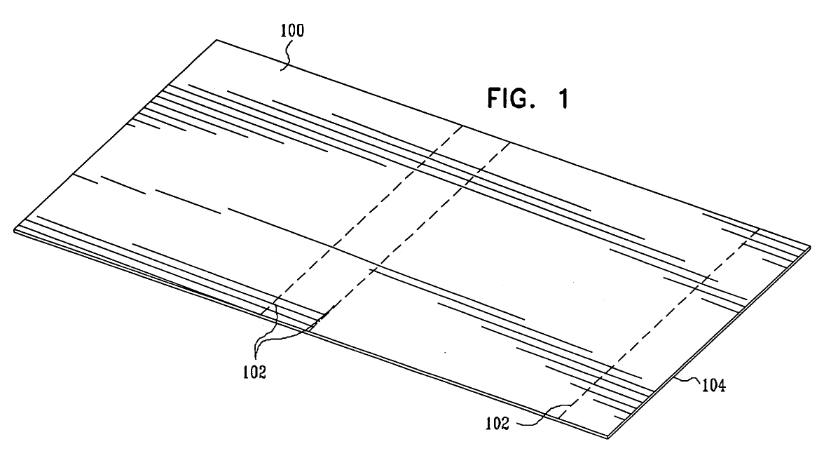

Reference is now made to FIG. 1, which is a simplified illustration of a scored cardboard blank useful in manufacturing a drawer enclosure constructed and operative in accordance with a preferred embodiment of the present invention. As seen in FIG. 1, a cardboard blank 100, which may be printed with any suitable content, such as decorative, advertising or other content, is formed with score lines 102.

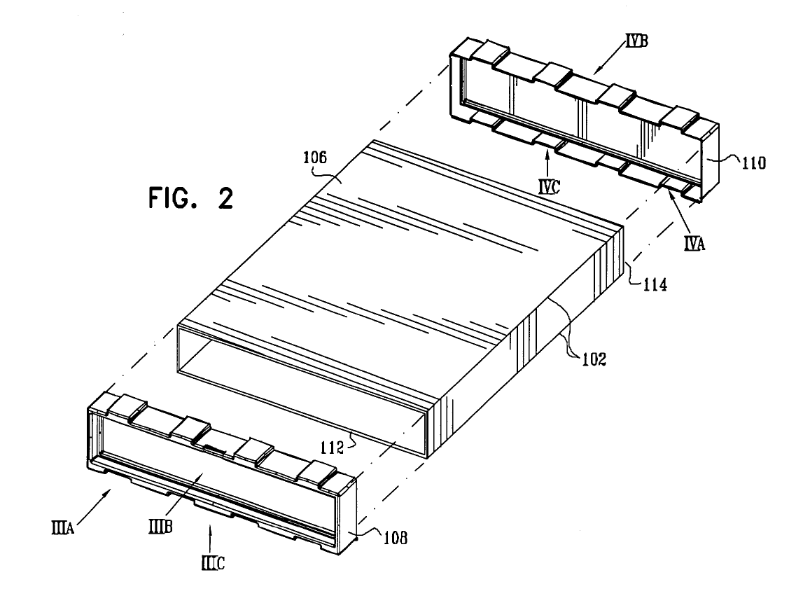

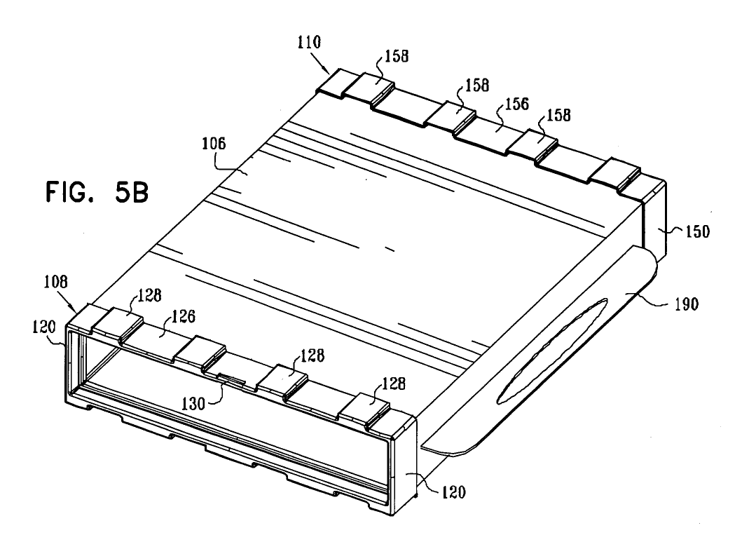

The blank 100 is preferably folded along score lines 102 and glued at a flap 104 to define a generally rectangular cylindrical open-ended enclosure 106, as seen in FIG. 2. Front and back end elements 108 and 110, preferably injection molded of plastic, are preferably adhesively adhered to the front end 112 and back end 114 of the enclosure 106. The completed enclosure is shown in FIG. 5A.

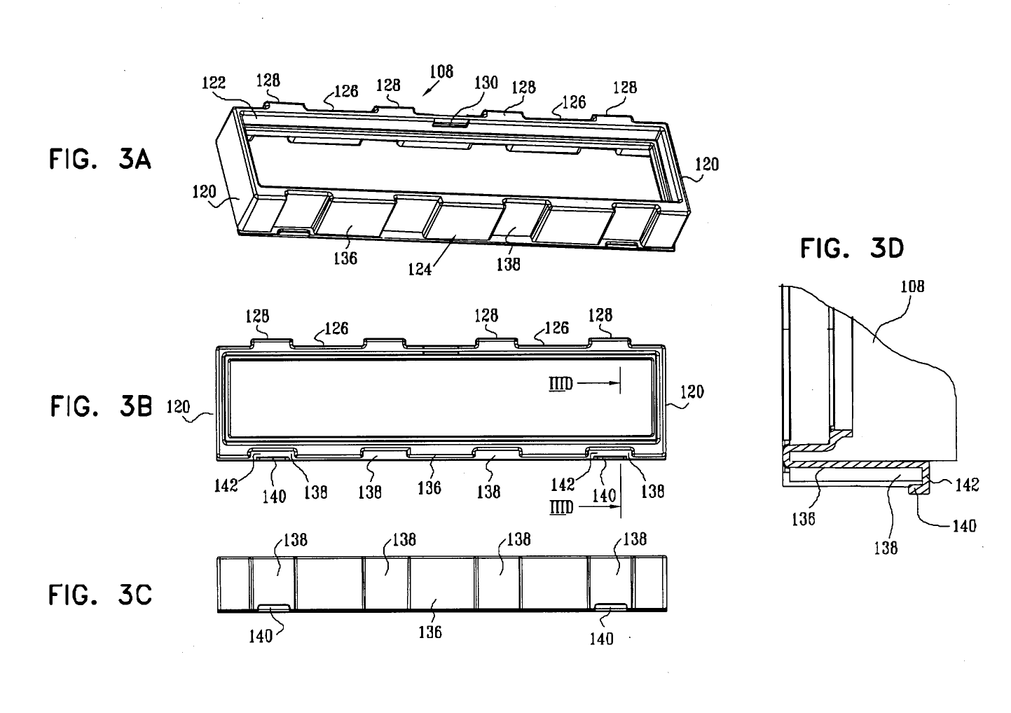

Reference is now made to FIGS. 3A, 3B, 3C and 3D, which are illustrations of the front end element 108, forming part of the drawer enclosure of FIG. 2, taken along arrows IIIA, IIIB and IIIC in FIG. 2 and section lines IIID-IIID in FIG. 3B. As seen in FIGS. 3A, 3B, 3C and 3D, the front end element 108 defines a generally rectangular frame, having a pair of identical side portions 120 integrally joined with a top portion 122 and a bottom portion 124.

Top portion 122 defines a top surface 126 having formed thereon a plurality of generally rectangular protrusions 128 which extend front to back of the top surface 126. Top surface 126 preferably is also formed with a slot 130, whose function is described hereinbelow.

Bottom portion 124 defines a bottom surface 136 having formed thereon a plurality of generally rectangular recesses 138 configured to receive corresponding protrusions 128 on an adjacent stacked front element. Recesses 138 extend from the front to the back of the bottom surface 136. Bottom portion 124 is particularly characterized in that it includes forward facing protruding latches 140, integrally formed with bottom surface 136 and mounted on a surface 142 depending from bottom surface 136 and extending perpendicularly thereto, at the back facing surface of at least two of recesses 138. Latches 140 are designed to slidably engage openings in corresponding protrusions 128 on an adjacent stacked front element and thus hold two mutually stacked drawer enclosures together.

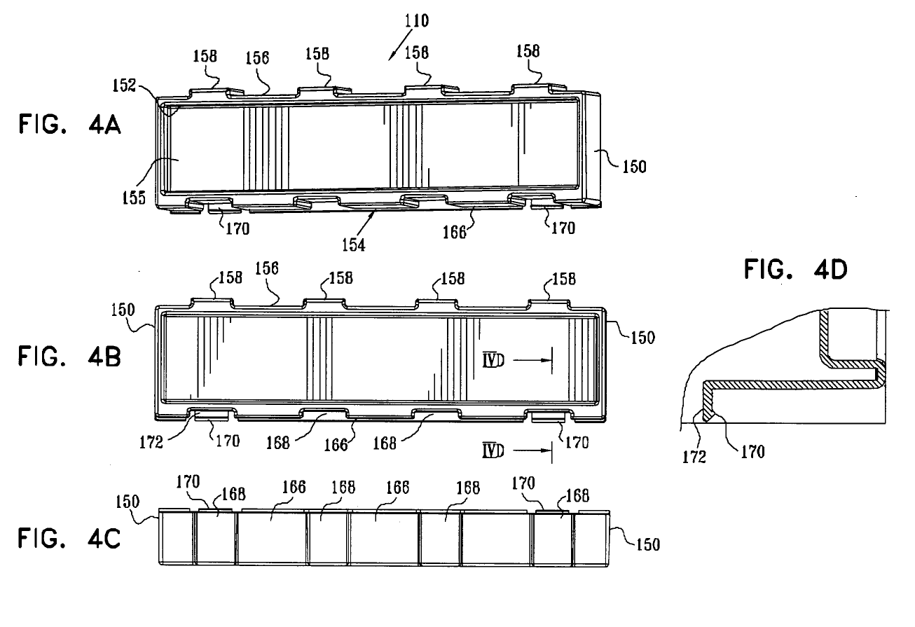

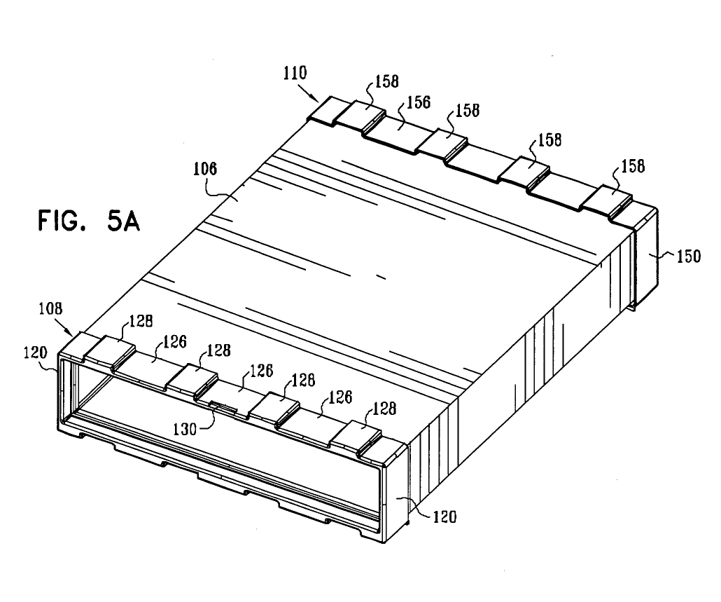

Reference is now made to FIGS. 4A, 4B, 4C and 4D, which are illustrations of the back end element 110, forming part of the drawer enclosure of FIG. 2, taken along arrows IVA, IVB and IVC in FIG. 2 and section lines IVD-IVD in FIG. 4B. As seen in FIGS. 4A, 4B, 4C and 4D, the back end element 110 defines a generally rectangular frame, having a pair of identical side portions 150 integrally joined with a top portion 152 and a bottom portion 154. As distinct from the front end element 108, which defines an open frame for receiving a drawer, the back end element 110 also includes a back surface 155 which closes the open back end 114 of the enclosure 106 (FIG. 2).

Top portion 152 defines a top surface 156 having formed thereon a plurality of generally rectangular protrusions 158 which extend from the front to the back of the top surface 156.

Bottom portion 154 defines a bottom surface 166 having formed thereon a plurality of generally rectangular recesses 168 configured to receive corresponding protrusions 158 on an adjacent stacked front element. Recesses 168 extend from the front to the back of the bottom surface 166. Bottom portion 154 is particularly characterized in that it includes back facing protruding latches 170, integrally formed with bottom surface 166 and mounted on a surface 172 depending from bottom surface 166 and extending generally perpendicularly thereto, at the back facing surface of at least two of recesses 168. Latches 170 are designed to clickably engage openings in corresponding protrusions 168 on an adjacent stacked front element and thus help to hold two mutually stacked drawer enclosures together.

FIG. 5A illustrates a completed drawer enclosure of the type described hereinabove with reference to FIGS. 1-4D. FIG. 5B illustrates a completed drawer enclosure constructed in a manner which may be identical to that described hereinabove with reference to FIGS. 1-5A but including an integral handle 190, which is defined by a suitably configured blank (not shown).

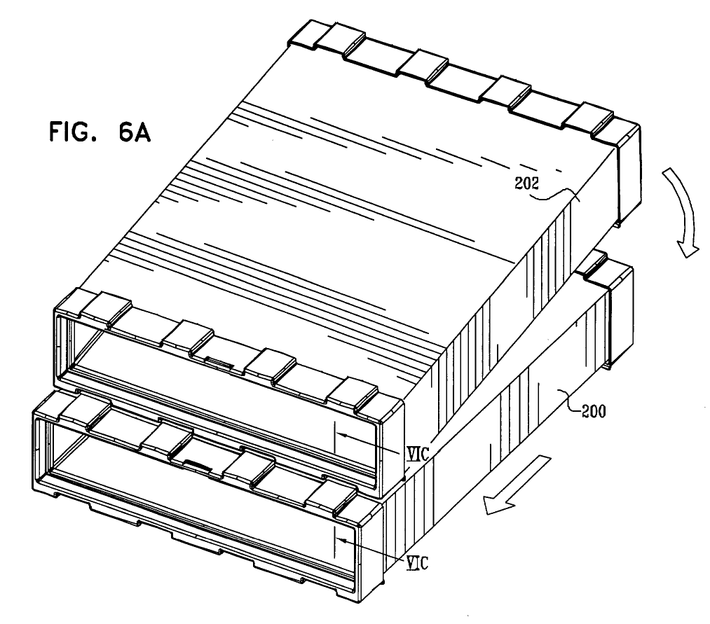

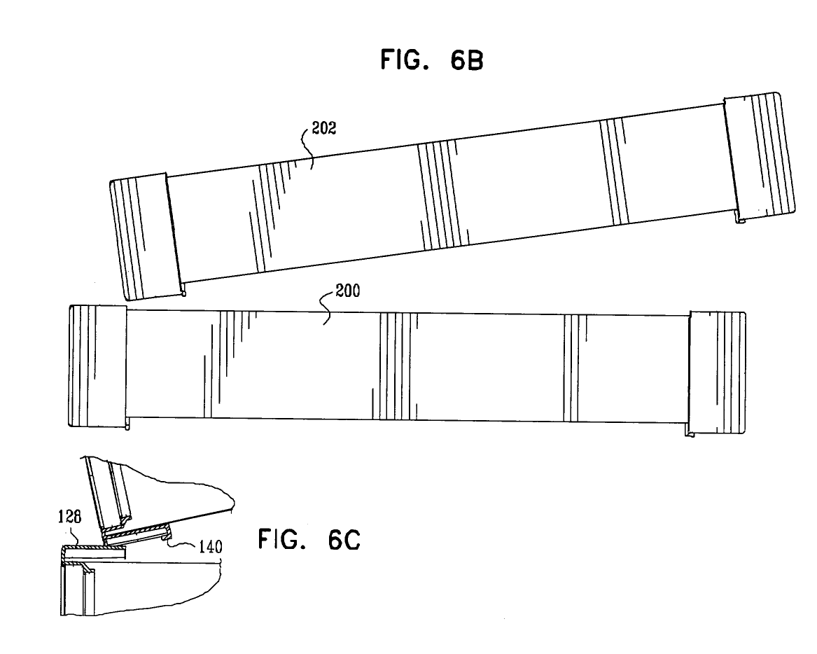

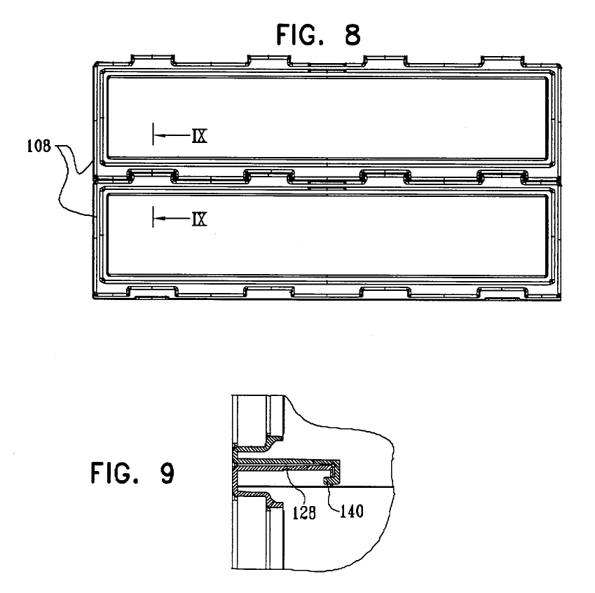

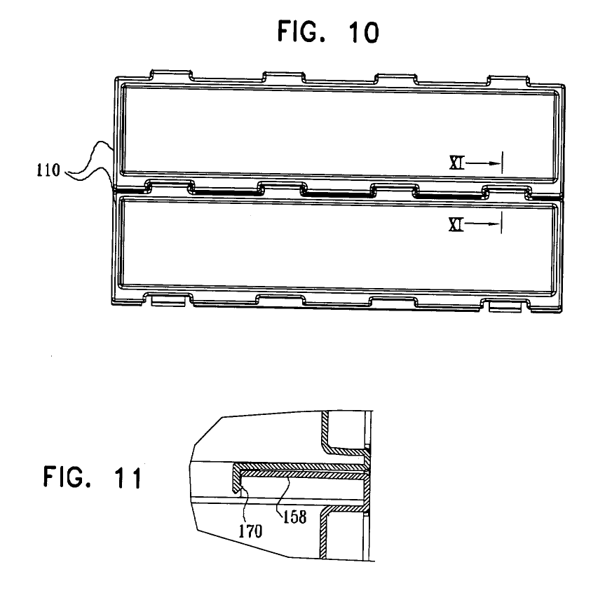

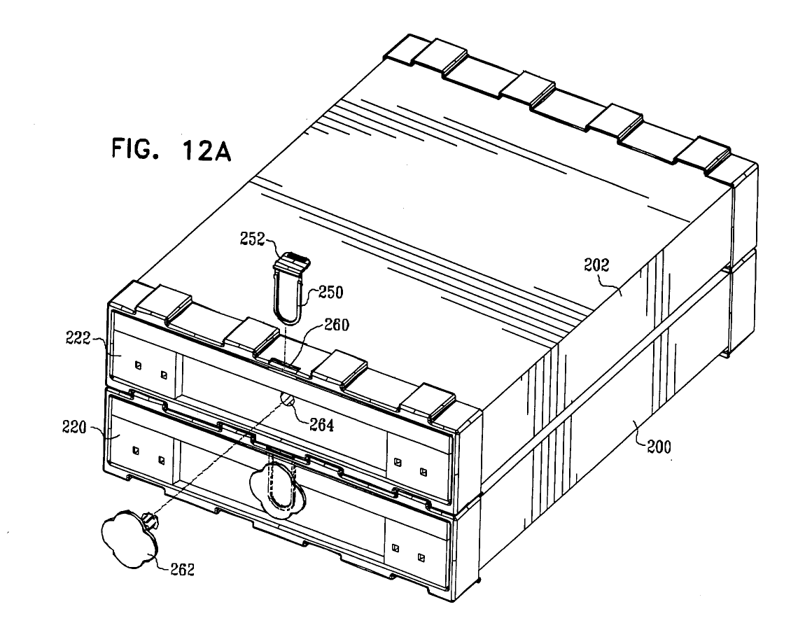

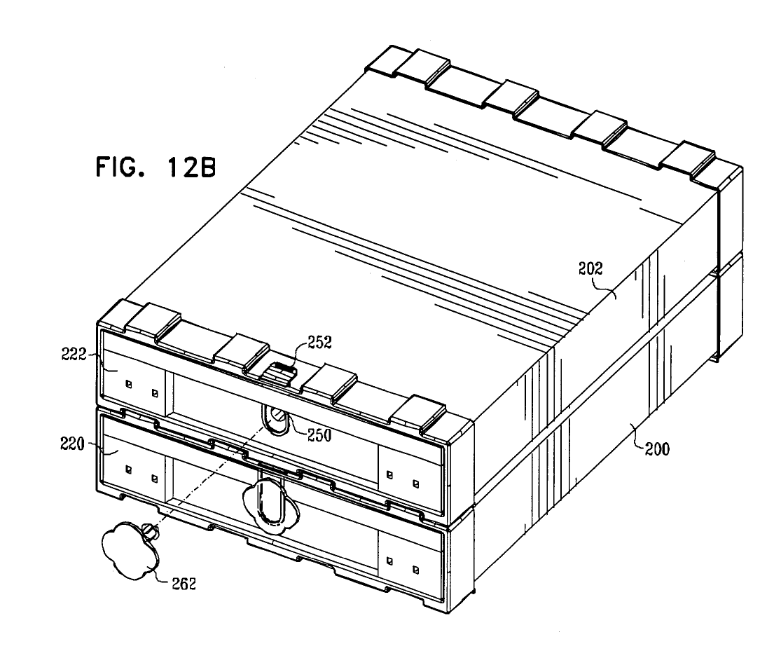

It is noted that preferably latches 170 provide a much less secure engagement with corresponding protrusions 158 than do latches 140 with protrusions 128. This arrangement is adapted for sliding and subsequently press and click engagement of mutually stacked drawer enclosures, as illustrated in FIGS. 6A, 6B and 6C and FIGS. 7A-11.

Turning to FIGS. 6A-6C, a pair of drawer enclosures 200 and 202 are shown just prior to sliding engagement of latches 140 with the openings in protrusions 128. Following sliding engagement of latches 140 with the openings in protrusions 128, the back of enclosure 202 is pushed down onto enclosure 200, causing protrusion 170 to click into engagement with the opening of protrusion 158.

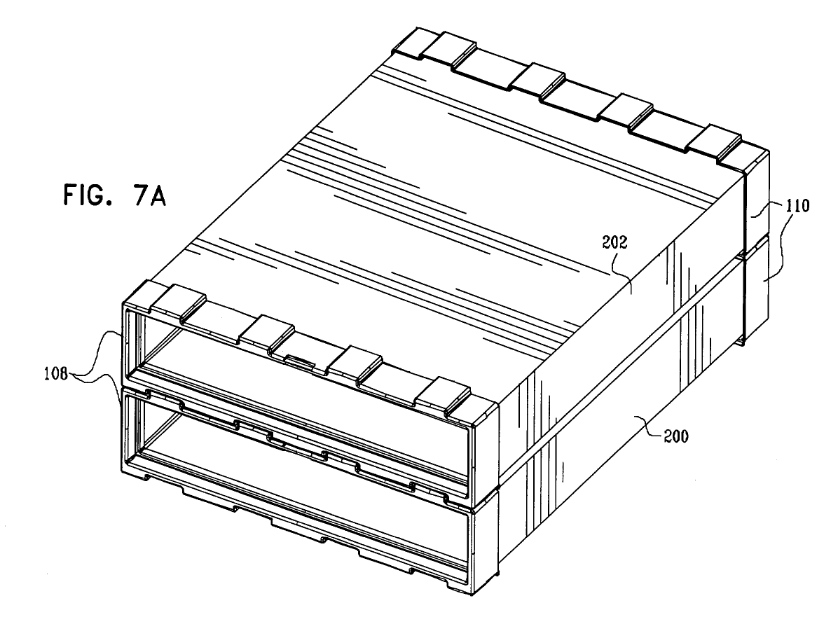

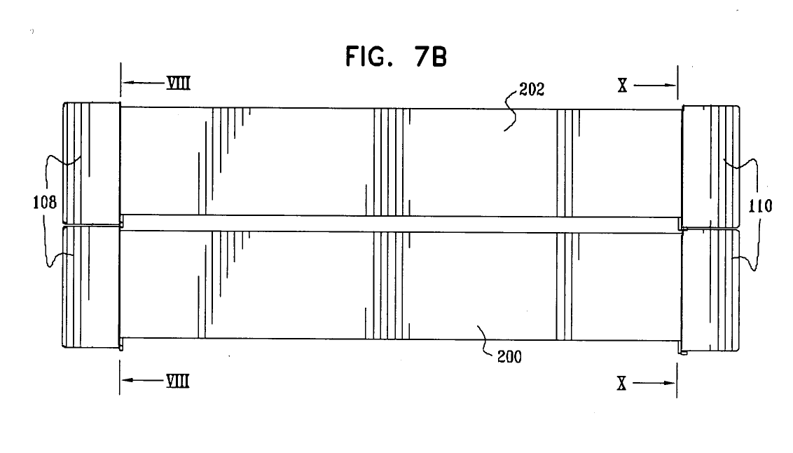

FIGS. 7A-11 illustrate full engagement between the respective latches 140 and protrusions 128 which retains drawer enclosures 200 and 202 together in stacked arrangement. It is appreciated that any suitable number of drawer enclosures 200 and 202 may be mutually held together and readily separated from each other in this manner.

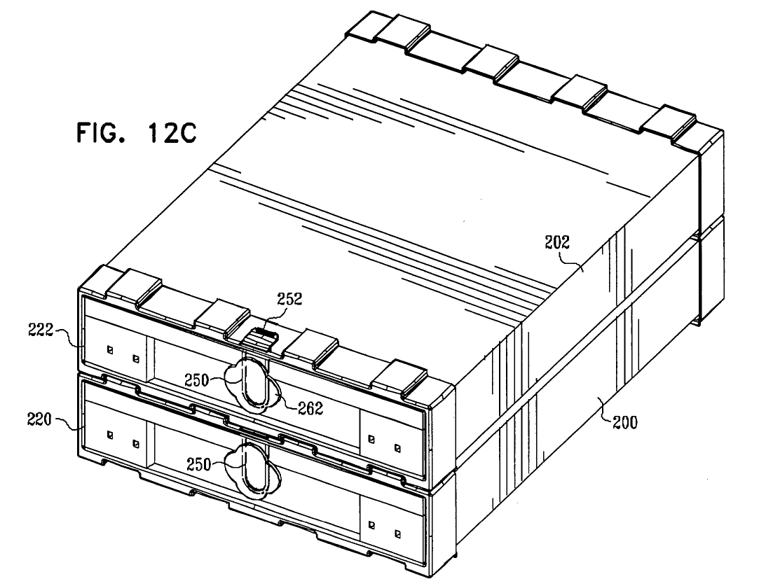

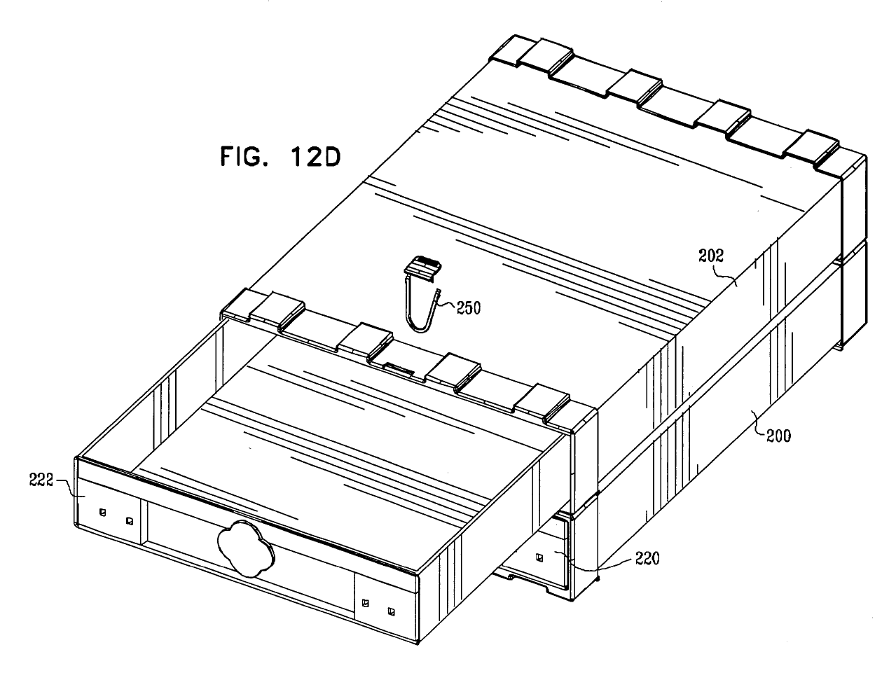

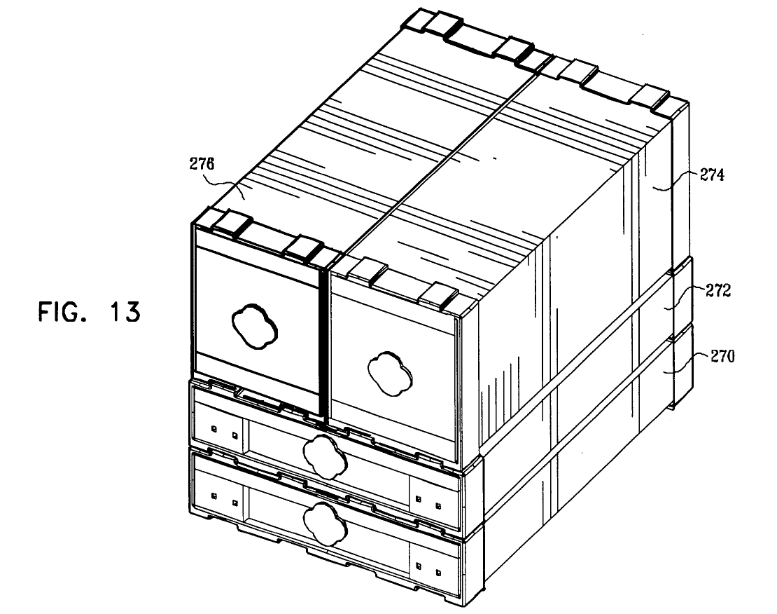

Reference is now made to FIGS. 12A-12D, which are pictorial illustrations showing securing and unsecuring drawers in drawer enclosures. As seen in FIGS. 12A-12D, drawers 220 and 222 are located within corresponding drawer enclosures 200 and 202. In accordance with a preferred embodiment of the present invention, unauthorized removal of the drawers from the drawer enclosures, such as in a retail environment prior to purchase by a consumer, may be prevented by placing a cuttable retaining ring 250, integrally formed with a tab 252, through a slot 260, corresponding to slot 130 (FIG. 3A).

As seen in FIGS. 12A and 12B, a drawer handle 262 is extended through ring 250 and snap fit into a mounting aperture 264 in drawer 222. In this way, as seen in FIG. 12C, ring 250 prevents the drawer 222 from being slid out of enclosure 202. If the ring 250 is subsequently cut from the tab 252 and removed, the drawer 222 can be slid out of the enclosure 202, as seen in FIG. 12D.

FIG. 13 is a pictorial illustration of one example of stacking disparately sized drawer enclosures 270, 272, 274 and 276 in accordance with a preferred embodiment of the present invention.

It will be appreciated by persons skilled in the art that the present invention is not limited to what has been particularly shown and described hereinabove. Rather the scope of the present invention includes both combinations and subcombinations of the various features described hereinabove as well as modifications and variations thereof as would occur to a person of skill in the art upon reading the foregoing specification and which are not in the prior art.

1. A stackable drawer enclosure comprising:
an enclosure element formed of carton; and
front and rear end elements formed of plastic, joined to said enclosure element and providing removable attachment with similar drawer enclosures stacked thereon.

2. A stackable drawer enclosure according to claim 1 and wherein said front end element also comprises a latch element.

3. A stackable drawer enclosure according to claim 2 and wherein said latch element slidably engages an opening in a corresponding protrusion formed in a corresponding stackable element.

4. A stackable drawer enclosure according to claim 1 and wherein said front end element also comprises a slot.

5. A stackable drawer enclosure according to claim 4 and wherein said slot is operative to engage a cuttable retaining ring.

6. A stackable drawer enclosure according to claim 1 and wherein said rear end element also comprises a latch.

7. A stackable drawer enclosure according to claim 6 and wherein said latch clickably engages an opening in a corresponding protrusion formed in a corresponding stackable element.

8. A stackable drawer enclosure comprising:
an enclosure element; and
front and rear end elements, joined to said enclosure element and providing removable attachment with similar drawer enclosures stacked thereon, at least one of said front and rear end elements including at least one slidable engagement protrusion and at least one slidable engagement recess arranged for mutual slidable engagement and disengagement between adjacent stacked drawer enclosures.

9. A stackable drawer enclosure according to claim 8 and wherein said front end element also comprises a slot.

10. A stackable drawer enclosure according to claim 9 and wherein said slot is operative to engage a cuttable retaining ring.
